(19) United States
(12) Patent Application Publication
(10) Pub. No.: US 2025/0270669 A1
(43) Pub. Date: Aug. 28, 2025

(54) METHOD FOR IRRIGATING A POROUS SUBSTRATE USING A FOAM, AND THE USES THEREOF

(71) Applicants: ORANO MINING, Chatillon (FR); COMMISSARIAT A L'ENERGIE ATOMIQUE ET AUX ENERGIES ALTERNATIVES, Paris (FR)

(72) Inventors: Nicolas DURUPT, Isle (FR); Sylvain FAURE, Venasque (FR); Fabien FRANCES, Saint-Julien De Peyrolas (FR); Agnès GRANDJEAN, Saint-Marcel-De-Careiret (FR)

(73) Assignees: ORANO MINING, Chatillon (FR); COMMISSARIAT A L'ENERGIE ATOMIQUE ET AUX ENERGIES ALTERNATIVES, Paris (FR)

(21) Appl. No.: 18/857,344

(22) PCT Filed: Apr. 18, 2023
(86) PCT No.: PCT/FR2023/050554

§ 371 Date: Oct. 16, 2024

(30) Foreign Application Priority Data
Apr. 19, 2022 (FR) 2203603

(51) Int. Cl. C22B 3/04; B09C 1/02

(52) U.S. Cl. CPC C22B 3/04; B09C 1/02

(57) ABSTRACT

The present invention relates to a method for irrigating a porous substrate comprising the steps of: preparing a foam consisting of a dispersion of air bubbles in a foaming aqueous solution, said foam comprising a liquid fraction of less than or equal to 15% by volume; spreading, over the surface of the porous substrate, a layer of the foam thus prepared, the thickness of the layer being greater than 5 cm, then maintaining the assembly long enough for at least a part of the liquid contained in the foam to infiltrate the porous substrate. The present invention also relates to the use of this method to recover an element of interest contained in a porous substrate and a particular aqueous foam.

### TECHNICAL FIELD

The present invention relates to the general field of porous substrates.

In fact, the present invention proposes a method for irrigating a porous substrate via the surface thereof homogeneously, and this by using, in contact with the surface, a layer of aqueous foam that has a liquid fraction (or gas fraction) and a height that are controlled.

Such a method has a particular advantage in irrigating porous substrates such as ores, or agricultural or horticultural land, with a view to providing them with an aqueous solution (water or water with additive) allowing, according to the application sought:
treatment of the substrate by heap or column leaching, allowing the solubilisation or entrainment of reprocessable materials (ores, recyclable/reprocessable strategic or polluting metals);
simple watering in the sense of the homogeneous and controlled addition of water over a given depth of the substrate;
nutritive or curative or decontaminating treatment in the case of soils, planted or not.

### Prior Art

For treating ores, including for example uranium ore, heap leaching is in particular used for leaching so-called “low-grade” ore. Ores with a high uranium content are for their part treated by leaching in reactors.

Leaching in reactors is also used on urban mines, in the recycling of industrial, metallurgical and electronic waste in order to separate/recycle strategic metals particularly sought by the new-technology industry for their electronic, magnetic, optical and catalytic properties. This waste can be a source of precious metals such as, for example, gold, silver, platinum and palladium. Current industrial methods based on hydrometallurgy have a first step of pre-treatment via coarse grinding and then selective grinding or physical sorting, for separating the plastic compounds from the metal compounds. A step of leaching in reactors then follows, requiring the use of a large quantity of reagents and large reactor volumes. Alternative biological leaching methods are also being studied in order to minimise the environmental impact. However, these methods have low yield and require lengthy action time.

Heap leaching has been used for treating low-grade uranium ores since the 1950s and consists in crushing the ore before placing it in a heap and then irrigating it with an acidic leaching solution. The leaching yields are not very high, of the order of 50 to 70%.

The most used heap leaching method consists first of all in forming the heap by crushing the ore and then agglomerating it in concentrated sulfuric acid in “pralines” of several hundreds of μm to a few tens of mm before forming a heap several metres in height. It is then sprinkled, dropwise, with a dilute sulfuric acid solution corresponding to the “leaching solution”.

The heap is sprinkled for several months with the acidic leaching solution by means of a drip system supplied by “pipes” deposited directly on the heap. Industrially, the space between the pipes is several tens of cm, generally between 50 and 80 cm.

The pre-dissolved uranium, during the phase of agglomerating the ore, in the concentrated acid, is leached by the dilute acid solution that infiltrates and circulates gently by gravity in the porosity of the heap. The mean time for passing through the various heaps is generally between 3 and 6 days. The leaching solution loaded with elements of interest (uranium in this case) is finally collected by draining in a pool before undergoing a series of other treatments aimed at concentrating and then purifying the uranium, and also recycling the acid to reuse it at the top of the heap.

Ghorbani et al report the importance of the permeability of the heap during leaching [1]. The speed of flow of the leaching solution in the heap must, generally, be sufficiently low to allow the reaction between the solution and the target ores and the same time sufficiently rapid to avoid the accumulation of water on the surface of the heap, causing the formation of puddles.

Moreover, local permeability is often non-homogeneous in the heap, and preferential pathways may form in the heap, leading to accelerated percolation of the solutions through it, some zones of the heap never being leached. This variation in permeability may result from an effect of compacting of the heap but is usually connected to the nature of the ore and, in particular, to the presence of fine particles of clays or particles of plant or organic origin. The heap of ore can by analogy be compared to a layer of soil (porous medium). Inside a porous medium of the sand or soil type, the speed of flow of the water or permeation depends on the geometry of the pores of the soil but also on the differences in hydraulic load present inside the soil. Darcy's law is the equation that connects the hydraulic load (pressure) to the speed of flow of the water in a unidimensional flow. This law is written in the form (I):

$$V = ki \qquad ( I )$$

with “V” corresponding to the speed of flow, “i” to the hydraulic gradient, which is equal to “-dh/dx” (unidimensional flow in the direction Ox), and “k” to the coefficient of proportionality, also referred to as “coefficient of permeability”.

Two main limitations on the extraction yield for an irrigation method of the “drip” type by pipes have been identified.

The first limitation found industrially on the heap leaching of the most permeable ores is that drip irrigation of the acidic solution is not homogeneous. On the surface, the heap is best sprinkled in proximity to the pipes and there are “dry” zones not sprinkled on the surface between the pipes. In addition, preferential percolation paths in the porosity of the heap form.

The second limitation is observed on so-called “clogging” ores: the presence of numerous fine particles and, in particular, clay particles causes the appearance of clogging phenomena and creates preferential paths inside the heap. They also cause the formation of puddles of solution on the surface of the heap, which can cause losses of leaching solution by evaporation.

Leaching methods using foams have also been described in the prior art.

The patent U.S. Pat. No. 4,080,419 proposes a method for leaching a fragmented ore using a foam generated in situ [2]. More particularly, a non-ionic surfactant such as 4-nonylphenyl-polyethylene glycol (Tergitol™ NPX) is added to the leaching solution, which is dispersed in the heap before air is added upwards by means of which the foam is generated. It should be noted however that the patent U.S. Pat. No. 4,080,419 [2] also envisages using a high-density foam, obtained using CO₂ or halogenated hydrocarbon vapours (column 5, last paragraph). According to a particular embodiment, the foam is sprayed directly at the surface of the heap and then, by virtue of its high density, diffuses inside the high-porosity coarse heap.

In the patent U.S. Pat. No. 6,099,615 [3], a solution containing a surfactant or a foaming agent is put in contact with the ore and foam is formed while the ore is crushed, conveyed or agglomerated, i.e. before the heap is formed. This prior treatment is used for promoting the permeability of the heap and avoiding the formation of preferential paths therein.

Likewise, the patent application US 2013/045052 [4] envisages using a foam in treating an excavation deposit in order to reduce contamination of the water and to facilitate recovery of constituents of value. After the dispersion of the foam on the excavation deposit, means such as boring are used to inject it in the deposit, by means of which it spreads therein, upwards, downwards and circumferentially. The method described in the patent application US 2013/045052 [4] therefore requires means, in particular mechanical, for promoting the injection of the foam in the deposit.

Finally, the Applicants have already proposed decontamination or disinfecting foams all comprising a foaming surfactant and a gelling or viscosifying agent, respectively in the international application WO 2004/008463 [5] and in the international application WO 2016/202879 [6].

The inventors set out to propose a method responding to the technical problems of the irrigation methods in general. More particularly, these problems are in particular the non-homogeneities of treatment of the surfaces and the difficulties in controlling the quantities/flow rates of irrigation liquids, whether for heap leaching of ores or the treatment of soils. The method of the invention must therefore guarantee above all a homogeneous treatment of the surface of the substrate and provide a controlled irrigation flow adapted to the application. The irrigation flow of said method gives rise to a sufficient contact time of the solution with the substrate, thus favouring the recovery of elements of interest present in the heap or the inactivation of the polluting elements of a soil or again the addition of elements of agronomic interest to a soil.

### DESCRIPTION OF THE INVENTION

The present invention makes it possible to achieve the aim that the inventors set for themselves. Indeed the latter propose a method that is easy to implement and has low environmental impact since it requires neither expensive technical devices nor dangerous reagents, by means of which, for example, it is possible to effectively recover elements of interest in the context of heap leaching, while minimising the quantities of effluent to be treated subsequently.

More particularly, the inventors have shown that it is possible to improve the irrigation of a heap making it possible to optimise the irrigation efficiency and, thereby, the efficiency of recovery or extraction of the elements of interest contained therein. This improvement is obtained by using a foam consisting of a dispersion of air bubbles in a foaming aqueous solution whose the liquid fraction and the height used are controlled.

For the most permeable heaps, irrigation by a layer of aqueous foam such as implemented in the invention, deposited homogeneously over the entire surface of the heap, guarantees homogeneous distribution of the irrigation flow on the surface of the heap and avoids non-sprinkled zones, in particular in the case of divided ores or solids resulting from urban mine waste.

Likewise, for low-permeability heaps, the irrigation rates are sometimes too high at the injection point and puddles form on the surface, going as far as inundating the whole of the surface. Irrigation by a layer of foam makes it possible, in particular according to the liquid fraction and height thereof, to modulate the irrigation flow by controlling the gravity drainage within the foam and thus avoid the formation of puddles on the heap.

All these advantages are obtained without its being necessary to force the penetration of the foam in the heap in particular by injection means such as tubes, pipes and drillings.

In this regard, it should be noted that it was not at all obvious to use a foam consisting of a dispersion of air bubbles in a foaming aqueous solution having regard to the teaching of the patent U.S. Pat. No. 4,080,419 [2], which envisages using a foam obtained using CO₂ or halogenated hydrocarbon vapours and able to have, by virtue of its high density, a rapid descending movement following the deposition thereof on the surface of the heap. The inventors have shown that a descending movement of the liquid contained in the foam can be obtained with an air-bubble foam by selecting a suitable liquid fraction and use height.

Remarkably, the properties of the foam used in the present invention can be used not only in heap leaching methods but also in agriculture, agronomy and horticulture.

Indeed, for applications on watering soils in agriculture, agronomy and horticulture or for the nutritive or curative treatment of these soils, sprinkler or drip methods via pipes consume water and the irrigation is, as for heap leaching of ore, usually non-homogeneous. Irrigation by the “foam technique” according to the invention allows homogeneous treatment of the surface of the soil in which a controlled addition of water over the first centimetres of the soil, such as for example the first 10 to 30 centimetres, makes it possible to economise on the water used and guarantees a homogeneous and effective contribution of elements of agronomic interest. In this case, improving the efficiency obtained via the method according to the invention corresponds to improving the efficiency of agricultural or horticultural production for a quantity of water added.

Finally, the irrigation foam used in the invention can also be used for decontaminating in situ a soil contaminated over a given depth by biological agents such as for example bacteria, viruses, fungi and toxins, or by chemical agents such as for example organophosphorus compounds and organic solvents.

In general terms, the present invention relates to an irrigation method consisting in depositing, on a porous substrate such as for example a leaching heap or a soil, a layer of foam of adapted formulation with a thickness greater than 5 cm (bound not included) and a liquid fraction of less than or equal to 15% by volume.

In other words, the present invention relates to a method for irrigating a porous substrate comprising the steps consisting in:
preparing a foam consisting of a dispersion of air bubbles in a foaming aqueous solution, said foam comprising a liquid fraction of less than or equal to 15% by volume,
spreading, over the surface of the porous substrate, a layer of the foam thus prepared, the thickness of the layer being greater than 5 cm, then
maintaining the whole for sufficient time for at least a part of the liquid contained in the foam to percolate in the porous substrate.

“Irrigating a porous substrate” means, in the context of the present invention, a homogeneous addition, by infiltration or percolation, of a liquid in the porous substrate. More particularly, the foam with controlled moisture content and height, used in the context of the method according to the invention, completely covers and wets the surface of the porous substrate, and gravity drainage in the foam therefore homogeneously irrigates the porous substrate.

“Porous substrate” means a substrate in particulate, fragmentary and/or lumpy form. The constituents of this substrate are aggregates of organic and/or inorganic elements, resulting from natural processes or grinding, crushing and/or agglomeration methods such as agglomeration with sulfuric acid, to form ore pralines. The pores of such a porous substrate correspond to the empty spaces present between the aggregates of elements constituting it. The size of these aggregates can range from a few micrometres to several centimetres.

Typically, the porous substrate irrigated by the method according to the invention is selected from the group consisting of land such as bare land for agricultural activity, cultivated agricultural land, a green space, a stadium or terrain for sporting activity or a horticultural garden; sand; broken or fractured geological rocky formations; ore; ore concentrates; coal; mining residues; mining waste; slag; industrial, metallurgical and electronic waste; products containing strategic metals such as for example nickel, cobalt and manganese, resulting from the recycling of lithium batteries, also known by the English expression “black mass”, and one of the mixtures thereof.

In a particular embodiment, the irrigated porous substrate can be in the form of a heap prepared prior to the implementation of the method according to the invention, and this by any technique known to a person skilled in the art. This embodiment is in particular adapted to the porous substrate liable to contain one or more elements of interest such as metals and ores such as for example gold, silver, uranium, platinum, palladium, lithium, nickel, cobalt, manganese, aluminum, zinc, copper, rare earths, niobium, tantalum, scandium and chromium.

The first step of the method according to the invention consists in preparing an aqueous foam with controlled moisture content from a foaming solution.

The foaming solution used for preparing the aqueous foam used in the method according to the invention comprises, as a solvent, water, thus justifying the expression of foaming aqueous solution. “Water” means tap water, deionised water or distilled water. Advantageously, the aqueous foam used in the method according to the invention can be a neutral, acidic or basic foam, and this in particular according to any additional active ingredient or ingredients that it may contain.

The foaming aqueous solution used for preparing the aqueous foam used in the method according to the invention comprises at least one foaming organic surfactant.

“Organic surfactant” means an organic molecule including a lipophilic (apolar) part and a hydrophilic (polar) part. “Foaming organic surfactant” means an organic surfactant as previously defined furthermore having a hydrophilic/lipophilic balance (HLB) of between 3 and 8. For the record, the HLB value of a surfactant can be obtained easily by means of the Davies equation [7] and the HLB tables for various chemical groups, available for a person skilled in the art.

In particular, the foaming aqueous solution constituting the aqueous foam used in the invention can comprise a single foaming organic surfactant or a mixture of at least two foaming organic surfactants selected from non-ionic foaming surfactants, anionic foaming surfactants, cationic foaming surfactants, amphoteric surfactants, surfactants with a structure of the bolaform type, surfactants with a structure of the Gemini type and polymeric surfactants.

More particularly, the foaming aqueous solution used in the present invention comprises a single foaming organic surfactant or a mixture of at least two foaming organic surfactants selected from non-ionic foaming surfactants, anionic foaming surfactants and cationic foaming surfactants. In the mixtures of foaming organic surfactants, at least two surfactants are selected from the same family or from two different families selected from non-ionic foaming surfactants, anionic foaming surfactants and cationic foaming surfactants.

A person skilled in the art will find information with regard to anionic foaming surfactants and cationic foaming surfactants that can be used in the invention, in the international application WO 2016/202879 [6].

More particularly again, said at least one foaming organic surfactant contained in the foaming aqueous solution used in the context of the present invention is at least one non-ionic foaming organic surfactant. In other words, the foaming aqueous solution used in the context of the present invention comprises a single non-ionic foaming surfactant or a mixture of at least two non-ionic foaming surfactants.

For the record, non-ionic (or neutral) surfactants are compounds the surfactant properties of which, in particular hydrophilic, are provided by non-charged functional groups such as an alcohol, an ether, an ester or an amide, and may contain heteroatoms such as nitrogen or oxygen. Because of the small hydrophilic contribution of these functions, non-ionic surfactant compounds are usually polyfunctional. In the context of the present invention, the non-ionic foaming surfactants are in particular selected from alkyl alkoxylates; fatty alcohol alkoxylates; fatty amine alkoxylates; fatty acid alkoxylates; oxoalcohol alkoxylates; alkylphenol alkoxylates; alkyl ethoxylates; fatty alcohol ethoxylates; fatty amine ethoxylates; fatty acid ethoxylates; oxoalcohol ethoxylates; alkylphenol ethoxylates such as for example octylphenol and nonylphenol ethoxylates; alcohols, α-diols, polyethoxylated and polypropoxylated alkylphenols having a fatty chain including, for example, 8 to 18 carbon atoms, the number of ethylene oxide or propylene oxide groups being able in particular to be from 2 to 50; complex polymers of polyethylene and polypropylene oxide; copolymers of ethylene and propylene oxide; block copolymers of polyethylene and polypropylene oxides such as for example POE-POP-POE triblock copolymers; ethoxylated fatty alcohols; condensates of ethylene and propylene oxide on fatty alcohols, polyethoxylated fatty amides preferably having from 2 to 30 moles of ethylene oxide; polyethoxylated ethers preferably having from 2 to 30 moles of ethylene oxide; monoesters (monolaurate, monomyristate, monostearate, monopalmitate, monooleate, etc) and polyesters of fatty acids and of glycerol; polyglycerol fatty amides including on average 1 to 5 and more especially from 1.5 to 4 glycerol groups; fatty acid esters of oxyethylene sorbitan including from 2 to 30 moles of ethylene oxide; monoesters (monolaurate, monomyristate, monostearate, monopalmitate, monooleate, etc) and polyesters of fatty acids and of sorbitan, polyoxyethylene sorbitan monoesters; sucrose fatty acid esters; polyethyleneglycol fatty acid esters; alkylpolyglucosides; derivatives of N-alkyl glucamine and oxides of amines such as oxides of alkyl(C₁₀-C₁₄) amines or oxides of N-acylaminopropylmorpholine; polyols (surfactants derived from sugars), in particular glucose alkylates such as for example glucose hexanate; surfactants derived from glucoside (sorbitol laurate) or from polyols such as glycerol alcohol ethers; alkanolamides and mixtures thereof.

Advantageously, said at least one foaming organic surfactant contained in the foaming aqueous solution used in the present method according to the invention is selected from the group consisting of alkylpolyglucosides, ethoxylated fatty alcohols and mixtures thereof. Thus, by way of non-ionic foaming surfactants that can be used in the context of the present invention, it is possible to employ one or more alkyl polyglucosides and/or one or more ethoxylated fatty alcohols and, in particular, one or more alkyl polyglucosides of the Glucopon® family such as “Glucopon® 215 CS” marketed by the company BASF and/or one or more C8-C11 ethoxylated fatty alcohols for the lipophilic part and comprising 8 units coming from ethylene oxide in the hydrophilic part of formula: CH₃—(CH₂)₈₋₁₀—(OC₂H₄)₈OH marketed by the company FEVDI.

In the foaming aqueous solution forming the aqueous foam used in the method according to the invention, said at least one foaming organic surfactant, i.e. the foaming organic surfactant or the mixture of at least two foaming organic surfactants, is present, per litre of solution, in a quantity of between 0.1 and 10 g, notably between 1 and 9 g, in particular 2 and 8 g and more particularly between 3 and 7 g.

Thus, in a particular embodiment, the foaming aqueous solution constituting the aqueous foam used in the method according to the invention comprises or consists of:
one or more foaming organic surfactants as previously defined, and
water.

In this particular embodiment, the irrigation method of the invention is a simple method for sprinkling the porous substrate, i.e. a method for homogeneously providing water to the porous substrate.

In another particular embodiment, the foaming aqueous solution constituting the aqueous foam used in the method according to the invention can comprise, in addition to at least one foaming organic surfactant as previously defined and water, at least one gelling or viscosifying organic agent.

Advantageously, such a gelling or viscosifying organic agent is a biodegradable pseudo-plastic agent making it possible to further stabilise the aqueous foam and slow down the drainage and permeation flows through the porous substrate.

The gelling or viscosifying organic agent or agents that the foaming aqueous solution can contain is/are, more particularly, selected from hydrosoluble polymers, hydrocolloids, heteropolysaccharides such as, for example, polyglucoside polymers with trisaccharide branched chains, cellulose derivatives and polysaccharides such as polysaccharides containing glucose as a single monomer. By way of particular examples, the gelling or viscosifying organic agent or agents that can be used in the context of the present invention is/are selected from the group consisting of xanthan gum, carboxymethylcellulose and a mixture thereof.

In the foaming aqueous solution forming the aqueous foam used in the method according to the invention, said at least one gelling or viscosifying organic agent, i.e. the gelling or viscosifying organic agent, or the mixture of at least two gelling or viscosifying organic agents, is present, per litre of solution, in a quantity of between 0.5 and 8 g, notably between 1 and 5 g, and in particular between 1.5 and 3 g.

Thus, in a particular embodiment, the foaming aqueous solution constituting the aqueous foam used in the method according to the invention comprises or consists of:
one or more foaming organic surfactants as previously defined,
one or more gelling or viscosifying organic agents as previously defined, and
water.

In this particular embodiment, the irrigation method of the invention is also a simple method for sprinkling the porous substrate, i.e. a method for homogeneously providing water to the porous substrate.

In a variant, the foaming aqueous solution constituting the aqueous foam used in the method according to the invention may contain no gelling or viscosifying organic agent.

In another particular embodiment, the foaming aqueous solution constituting the aqueous foam used in the method according to the invention can comprise at least one active ingredient, in addition to at least one foaming organic surfactant as previously defined, water, and optionally at least one gelling or viscosifying organic agent as previously defined.

“Active ingredient” means a chemically or biologically active ingredient, in particular able to facilitate the recovery, the detoxification/decontamination and/or the immobilisation of at least one element of interest as previously defined and/or able to improve agricultural or horticultural production and yields either directly or by acting on an external factor that affects this production.

Any active ingredient having any one of the abilities listed above can be used in the context of the present invention. This active ingredient may be soluble in the foaming aqueous solution. In a variant, it may be insoluble therein, the mixture between the active ingredient and the aqueous foaming solution thus forming a dispersion. Likewise, it is obvious that, depending on the active ingredient or ingredients present in the foaming aqueous solution, the other components thereof, such as the foaming organic surfactant or surfactants and optionally the gelling or viscosifying organic agent or agents must be chosen so as not to be decomposable by the active ingredient or ingredients.

In a first particular embodiment, the active ingredient that the foaming aqueous solution can contain is able to facilitate the recovery, the detoxification and/or the immobilisation of at least one element of interest as previously defined. The active ingredients that can be used for this purpose are in particular those described in the patent U.S. Pat. No. 4,080,419 [2], the patent U.S. Pat. No. 6,099,615 [3] and the patent application US 2013/045052 [4] and in particular those described in Table II of the patent application US 2013/045052 [4]. In particular, the active ingredient that the foaming aqueous solution used in the invention may contain is selected from the group consisting of thiourea, a thiosulfate, a cyanide such as sodium cyanide, a bicarbonate such as sodium bicarbonate, an oxidant such as chlorine and an acid such as sulfuric acid, optionally associated with sulfate salts. More particularly, the active ingredient that the foaming aqueous solution used in the invention may contain is sulfuric acid in combination with one or more sulfate salts of a metal selected from the group consisting of magnesium sulfate, iron sulfate and aluminum sulfate. The experimental part illustrates such an active ingredient that can in particular be used for recovering uranium.

In this first particular embodiment, the foaming aqueous solution is a leaching solution.

In a second particular embodiment, the active ingredient that the foaming aqueous solution can contain is selected from the group consisting of fertilisers, biocides and phytosanitary products. In particular, this active ingredient is selected from the group consisting of fertilisers, manures, urease and nitrification inhibitors, insecticides, repellents, herbicides, fungicides, bactericides such as for example hydrogen peroxide and bleach water, sporicides, algicides, germination inhibitors and chelating/complexing agents.

In this second particular embodiment, the foaming aqueous solution is a solution useful for treating land as previously defined.

A person skilled in the art will be able to determine, without any inventive effort, the quantity of the active ingredient or ingredients to be used in the foaming aqueous solution according to their nature and the effect expected.

In a particular embodiment, the foaming aqueous solution constituting the aqueous foam used in the method according to the invention consists of or comprises:
one or more foaming organic surfactants as previously defined,
one or more active ingredients as previously defined, and
water.

In another particular embodiment, the foaming aqueous solution constituting the aqueous foam used in the method according to the invention consists of or comprises:
one or more foaming organic surfactants as previously defined,
one or more gelling or viscosifying organic agents as previously defined,
one or more active ingredients as previously defined, and
water.

As previously mentioned, the aqueous foam used in the method according to the invention has a controlled moisture level and therefore controlled swelling. For the record, a foam is often characterised by the expansion (F) thereof defined, under normal conditions of temperature and pressure, by the following formula (II):

$$F = ( {Vol}_{g a s} + {Vol}_{liquid} ) / {Vol}_{liquid} = {Vol}_{f o a m} / {Vol}_{liquid} = 1 / ε \qquad ( II )$$

Consequently, the moisture of a foam or liquid fraction (8) varies inversely as the expansion thereof and is therefore defined by the ratio Vol_{liquid}/Vol_{foam}. The expressions “moisture”, “liquid fraction” or “quantity of liquid” are equivalent herein and can be used interchangeably. These values are expressed by volume with respect to the total volume of the foam.

The aqueous foam used in the invention has a liquid fraction (or sometimes called moisture level) of less than or equal to 15% by volume and in particular between 5% and 15% by volume, which corresponds to an expansion greater than or equal to 6.67 and in particular between 6.67 and 20. It should be noted that the volume of liquid (Vol_{liquid}) in the above formula corresponds to the volumes of the various compounds mixed initially for preparing the foaming aqueous solution and in particular to the sum of the volume of the foaming organic surfactant or surfactants, the volume of any gelling or viscosifying organic agent or agents, the volume of any active ingredient or ingredients and of the volume of water.

The preparation of the aqueous foam used in the invention comprises a first step consisting in mixing together the water, the foaming organic surfactant or surfactants, any gelling or viscosifying organic agent or agents, and any active ingredient or ingredients, before the foam is generated. This mixing can be done by adding components in one go, in groups or one after the other. In a particular implementation, it can be envisaged preparing a 1^{st} solution by mixing together the water, the foaming organic surfactant or surfactants and any gelling or viscosifying organic agent or agents, and adding the active ingredient or ingredients to this solution only just before the foam is generated.

The second step of this preparation method consists in generating the foam. This step can be implemented by any system for generating foam of the prior art and known to a person skilled in the art. It is a case of any device providing the gas-liquid mixing, in particular by mechanical stirring, by bubbling, by static mixer containing beads or not, or by microbead tube foam generator, devices described in the international application WO 2016/202879 [6], or any other device, in particular spray nozzle systems or Venturi lance systems allowing high rates generally between 1 and 1000 m³/h. More particularly, the invention is of interest in the use of a foam generator that makes it possible to control the moisture level of the foam generated. This control of the moisture level is implemented by measuring the flow rate of solution and air mixed. The formulations of the invention easily make it possible to obtain a foam with the latter type of generator the moisture level of which is less than or equal to 15% by volume and in particular between 5% and 15% by volume.

The second step of the method according to the invention consists in applying, to the surface of the porous substrate, the foam prepared during the first step. This application is implemented in the form of a layer more than 5 cm thick.

Within the meaning of the present invention, “surface” must be taken to mean the boundary between the interior and exterior of the porous substrate, this exterior here corresponding to the atmosphere surrounding the substrate. When the porous substrate is in the form of a heap, the surface on which the aqueous foam is applied is the top part of the heap and optionally the top part of the slopes of the heap.

The steps of preparing and applying the foam can be implemented one after the other or simultaneously. In a particular embodiment, the steps of preparing and applying the foam are implemented simultaneously. In this embodiment, the foam is generated in proximity to and in particular above the surface of the porous substrate and is distributed over the latter by gravity. It is also possible to generate and apply the foam at various points at the surface of the porous substrate. The following experimental part illustrates technical means that can be used to do this.

The thickness of the layer of aqueous foam used in the method according to the invention is substantially uniform, apart from the edges of this layer. Advantageously, this thickness is between 5 cm and 30 cm and in particular between 5 and 10 cm. In these ranges, the bound “5 cm” is non-inclusive, whereas the bounds “30 cm” and “10 cm” can be inclusive.

Moreover, the application of the aqueous foam can be repeated, by means of which the foam is renewed by batches discontinuously or continuously at the surface of the porous substrate. When the porous substrate is in the form of a heap, this renewal makes it possible to ensure a moderate permeation/percolation flow at the outlet of the heap. “Moderate permeation/percolation flow at the outlet of the heap” means a flow of 3 to 75 L/(h·m²). For two consecutive batches, it is possible to apply aqueous foam in layers with identical or different thicknesses but greater than 5 cm. The layer of foam may also be renewed continuously at a rate adapted so as to maintain the constant thickness.

Typically, the application of the aqueous foam in a layer with a thickness greater than 5 cm at the surface of the porous substrate can be implemented at rates of 3 to 75 L/(h·m²) and in particular from 5 to 50 L/(h·m²).

The third step of the method according to the invention consists in maintaining the whole, i.e. the porous substrate and the foam applied to the latter, as it stands, i.e. without forcing, in particular mechanically, penetration of the foam inside the porous substrate. To the naked eye, the porous substrate and the foam applied to the latter are maintained in the static state.

Under such conditions, only the liquid contained in the aqueous foam applied at the surface of the porous substrate infiltrates, by gravity draining, in the latter. This infiltration takes place mainly downwards and circumferentially in the porous substrate.

It is obvious that the liquid contained in the foam that infiltrates in the porous substrate corresponds to the foaming aqueous solution used for preparing this foam. Consequently, the various elements contained in this foaming aqueous solution are found in the liquid that infiltrates in the porous substrate.

In addition, the present invention relates to a method for recovering at least one element of interest contained in a porous substrate in the form of a heap, said method comprising
irrigating the porous substrate in accordance with a method as previously defined, and
recovering the permeation flow at the discharge from the heap and treating same in order to recover said at least one element of interest.

In this method, the porous substrate is typically selected from the group consisting of land as previously defined; sand; broken or fractured geological rocky formations; ore; ore concentrates; coal; mining residues; mining waste; slag; industrial, metallurgical and electronic waste; products containing strategic metals resulting from the recycling of lithium batteries, and one of the mixtures thereof.

Likewise, said element of interest is advantageously selected from metals and ores and in particular selected from the group consisting of gold, silver, uranium, platinum, palladium, lithium, nickel, cobalt, manganese, aluminum, zinc, copper, rare earths, niobium, tantalum, scandium and chromium.

In addition, the foaming aqueous solution used for preparing the foam used during the irrigation step comprises at least one active ingredient able to facilitate the recovery, the detoxification and/or the immobilisation of at least one element of interest as previously defined.

The step of recovering the permeation or percolation flow at the discharge from the heap and processing same in order to recover one or more elements of interest is a conventional step in hydrometallurgical methods and in particular those involving a prior step of heap leaching. For this purpose, it should be noted that the permeation or percolation flow can be designated by the term “leachate”. In the latter, the element or elements of interest are in ionic form, dissolved in the leachate.

Treating the leachate in order to recover one or more elements of interest has recourse to techniques known to a person skilled in the art and generally involves a purification step followed by an optional hydrolysis step.

The purification step enables the various elements of interest to be separated from each other and from the other constituents present in the leachate such as the foaming surfactant or surfactants, the active ingredient or ingredients and optionally the gelling of viscosifying organic agents. Various techniques can be used for this purification such as for example liquid/liquid extraction by solvent, solid/liquid extraction, extraction on resin, cementation or precipitation. Following this purification, it is possible to recycle the foaming surfactant or surfactants and optionally the gelling or viscosifying organic agents at the process head in order to generate a new aqueous foam that is particularly useful in an irrigation method as defined in the present invention.

Finally, the present invention relates to a particular aqueous foam used in the method according to the invention. The latter consists of a dispersion of air bubbles in a foaming aqueous solution formed by:
a foaming organic surfactant in particular as previously defined or a mixture of foaming organic surfactants in particular as previously defined,
optionally an active ingredient in particular as previously defined or a mixture of active ingredients in particular as previously defined, and
water,
said foam having a liquid fraction of less than 15% by volume, i.e. an expansion greater than 6.67.

In a first embodiment, the aqueous foam according to the invention consists of a dispersion of air bubbles in a foaming aqueous solution formed by two elements that are:
a foaming organic surfactant in particular as previously defined or a mixture of foaming organic surfactants in particular as previously defined, and
water,
said foam having a liquid fraction of less than 15% by volume, i.e. an expansion greater than 6.67.

In a second embodiment, the aqueous foam according to the invention consists of a dispersion of air bubbles in a foaming aqueous solution formed by three elements that are:
a foaming organic surfactant in particular as previously defined or a mixture of foaming organic surfactants in particular as previously defined,
an active ingredient in particular as previously defined or a mixture of active ingredients in particular as previously defined, and
water,
said foam having a liquid fraction of less than 15% by volume, i.e. an expansion greater than 6.67.

Through its composition, the particular aqueous foam according to the present invention is clearly distinguished from the foams described in the international applications WO 2004/008463 [5] and WO 2016/202879 [6] through the absence of gelling or viscosifying organic agent.

Everything described above with regard to foaming organic surfactants, active ingredients and the respective quantities thereof as well as with regard to expansion in the context of the aqueous foam used in the irrigation method according to the invention also applies to the aqueous foam according to the invention.

Other features and advantages of the present invention will also emerge from the reading of the following examples given for illustrative and non-limitative purposes and referring to the accompanying figures.

### BRIEF DESCRIPTION OF THE DRAWINGS

FIG. 1 presents a diagrammatic representation of the assembly for studying infiltration, in the heap, of the drainage solution coming from a batch of foam.

FIG. 2 presents the influence over time of the height of foam on the flow.

FIG. 3 presents a test in successive batches with a foam with a liquid fraction of 5% and a height of 5 cm (4 batches) and of 10 cm (1 batch) in a column.

FIG. 4 presents the variation in the volume of permeate over time with 10 cm of ore and foams with a liquid fraction of 10% and a height of 10 to 30 cm.

FIG. 5 presents the comparison of the extraction yield of uranium for foam tests (columns C1 to C5) in accordance with the method according to the invention and drip tests (columns C-1 and C-2) according to the prior art with C1: Glucopon 2 g/L, 5 batches of 30 cm of foam and 2 batches of 60 cm; C2: Glucopon 10 g/L, 5 batches of 30 cm of foam and 2 batches of 60 cm; C3: Glucopon 10 g/L, 4 batches of 10 cm; C4: Glucopon 10 g/L, 9 batches of 5 cm; C5: Glucopon 10 g/L, 2 batches of 10 cm and 2 batches of 5 cm; C-1 and C-2: conventional drip irrigation with distributing geotextile on the heap.

FIG. 6 presents the partial covering of the heap of sand NE 34 by the foam via an ejection point with an inside diameter of 8 mm.

FIG. 7 presents the covering, on real ore, of the foam via an ejection by pipe in flush contact with the heap.

FIG. 8 presents the covering of the heap by foam ejected at 4 points on the surface of the heap of sand distant by 50 cm.

FIG. 9 presents the change in the flow as a function of time for a continuous test on 2 hours of injection of foam on sand.

FIG. 10 presents a diagrammatic representation of the liquid fraction gradient within a dome of foam supplied continuously at the end of two hours.

### DETAILED DESCRIPTION OF PARTICULAR EMBODIMENTS

The following examples relate to:
the irrigation, by a foam on a small heap surface, in a column 10 cm in diameter on sand, of models of ore heaps or on real uranium ore;
the leaching of uranium via this “foam” method on real ore; and
irrigation by covering a heap with a larger surface area: mason's sieve 45 cm or device of 2.25 m².

In the following experimental part and in the corresponding figures, when reference is made to a foam with 5 cm in thickness, it must be understood that this foam has a thickness slightly greater than 5 cm, i.e. a thickness of the order of 5.2 cm, i.e. 5.2 cm±0.1 cm.

### Example 1: Irrigation, by an Acidic Leaching Foam, of a Sand and Kaolinite Model Heap Agglomerated in a Column, in Discontinuous Batches

The leaching foaming solution of the example (preferred solution) comprises “Glucopon® 215 CS” marketed by the company BASF (hereinafter Glucopon), stable in a sulfuric acid medium (5 to 10 g/L) and the concentrations of acid and sulfate salts used are:
Sulfuric acid at 10 g/L,
Magnesium sulfate MgSO₄ at 30 g/L (i.e. 6 g/L of Mg),
Iron sulfate at 55 g/L (i.e. 20 g/L of Fe), and
Aluminum sulfate at 190 g/L (i.e. 15 g/L of Al).

A given volume of leaching acidic foam containing air bubbles (batch of foam with a given height of 5 to 60 cm) is generated from this solution by a bead-type static generator that makes it possible to control the liquid fraction of the foam (usually 5 to 10%, i.e. 90 to 95% air).

The volume of foam is deposited directly on 12 cm of a model heap (mixture of sand and kaolinite) pre-agglomerated in sulfuric acid in a liquid/solid ratio of 8% by volume, contained in a glass column 10 cm in diameter (i.e. 7.8×10⁻³ m²). The tests show that the foam deposited by a feed tube directly on the heap “bears”, under the effect of its own weight, on the heap and wets it homogeneously.

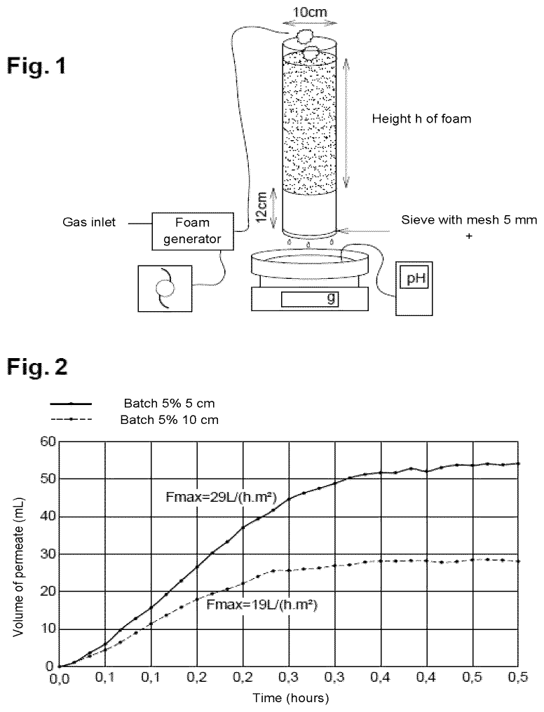

The experimental assembly shown schematically in FIG. 1 makes it possible to measure, by means of scales, the mass of solution that passes through the heap as a function of time, in order to calculate the permeation flow at each instant due to the irrigation by the foam (derived curves).

The tests on batches of foam with variable height and liquid fraction, implemented on a model heap of sand and kaolinite agglomerated in a column, made it possible to measure the maximum flow obtained in a batch of foam and the mean flow obtained during successive batches.

### A. Example of Maximum Flow

The permeation flow caused by the batch of foam increases with time, and passes to a maximum (slope at the point of inflection of the curves FIG. 2).

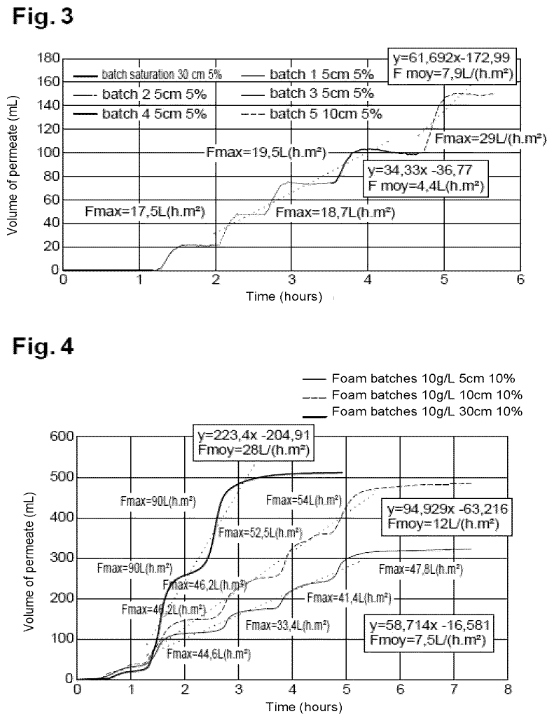

A small fraction of liquid (i.e. 5%) with batches of foam with a height either of 5±2 cm or of 10±2 cm makes it possible for example to obtain maximum flows of the order of 19±8 L/h/m² and of 29±6 L/h/m². These maximum flows correspond to the maximum of each of the slopes in FIG. 3.

To within any experimental errors, the double-height foam generates a doubled hydraulic pressure at the interface that doubles the permeation flow (Darcy's law). A Glucopon foam with a height of 5 cm and 5% liquid makes it possible to obtain the smallest maximum flows. Other tests (not provided here) also show the proportionality of the permeation flow with the liquid fraction of the foam.

### B. Examples of Mean Flows

Three successive batches of 5 to 10 cm of foam with 5% liquid fraction were implemented over several hours under conditions of leaching on agglomerated heap, after a first foam batch with a height of 30 cm called “saturation batch”, which makes it possible to completely saturate the heap and to obtain a percolating heap (height of 30 cm to provide enough liquid in a batch).

The graph in FIG. 3 presents a succession of four batches of 5 cm and one batch of 10 cm. The mean flows are calculated over a mean period of 45 min, for each of the 5 batches, which represents the time where the foam remains stable.

First a similar behaviour of the batches is noted over time when they follow each other on the same heap; around 20 L/(h·m²) for the maximum flow without the appearance of puddles. The mean permeation flow obtained semi-continuously is 4.4 L/(h·m²) over three times 45 min for 3 batches of foam with a height of 5 cm and a liquid fraction of 5%. These mean permeation flows are compatible with the industrial flows obtained in drip mode of the order of 5 L/(h·m²).

### Example 2: Leaching of Real Uranium Ore in Column Method (Effect of the Surfactant Content and Foam Height)

A test campaign with the leaching foams was implemented on an agglomerated uranium ore (500 ppm U). Five leaching columns with a diameter of 10 cm contain approximately 1 kg of ore each, i.e. 12 cm in height. The leaching foaming solution comprises Glucopon stable in a sulfuric acid medium (2 or 10 g/L) and the concentrations of acid and sulfate salts used are:
Sulfuric acid at 10 g/L,
Magnesium sulfate MgSO₄ at 30 g/L (i.e. 6 g/L of Mg),
Iron sulfate at 55 g/L (20 g/L of Fe),
Aluminum sulfate at 190 g/L (15 g/L of Al).

The measurements of uranium concentration in the permeates were made by x-ray fluorescence and by inductively coupled plasma atomic emission spectroscopy (ICP/AES).

The protocol used is as follows: upstream of the irrigation test, the ore is pre-agglomerated by a 3M sulfuric acid solution in a liquid/solid ratio of 8% (non-saturated ore) and then introduced into the column. The foam is then generated directly on the surface of the heap by means of an air-type foam generator via bead tube of 2-2.3 mm (flow rate of 1 to 2 L/min) connected to the compressed air system. This method makes it possible to control the liquid fraction (5 to 10%) and the height (5 to 60 cm) of the foam on the surface of the heap.

The leaching by layer of foam directly deposited on the heap of uranium is implemented discontinuously by replacing, every 45 to 60 min, the layer of foam with a previous given height and having drained, by a fresh layer of foam.

For several experiments implemented for example at 10 g/L of Glucopon and a foam with a fixed expansion F equal to 10 (i.e. 10% liquid fraction, the expansion being equal to the inverse of the volume liquid fraction) with heights varying from 10 to 30 cm and on a heap of real ore with a thickness of 12±2 cm (approximately 1.5 kg of ore) made it possible to evaluate the permeation flow of a method according to the invention (FIG. 4).

The mean flows calculated over one hour per batch are in the range from 7 to 28 L/(h·m²) and the maximum flows vary between 33 and 90 L/(h·m²).

A reduction in the concentration to 2 g/L of Glucopon was also able to be implemented in order to reduce the cost of the method associated with the use of surfactant. The behaviour of the foam at 2 g/L of Glucopon is similar to that of the foam at 10 g/L with a mean flow of 31 L/(h·m²) and a maximum flow of 86 L/(h·m²).

Finally, tests on reducing the permeation flow were implemented with a smaller foam height (5 cm) and greater swelling of 20. These conditions made it possible to obtain, in a very satisfactory manner, a mean flow of 4.3 L/(h·m²) and a maximum flow of 9-12 L/(h·m²). These results are entirely comparable to the permeation flows obtained industrially in drip mode (4 to 6 L/(h·m²).

### Leaching of Uranium

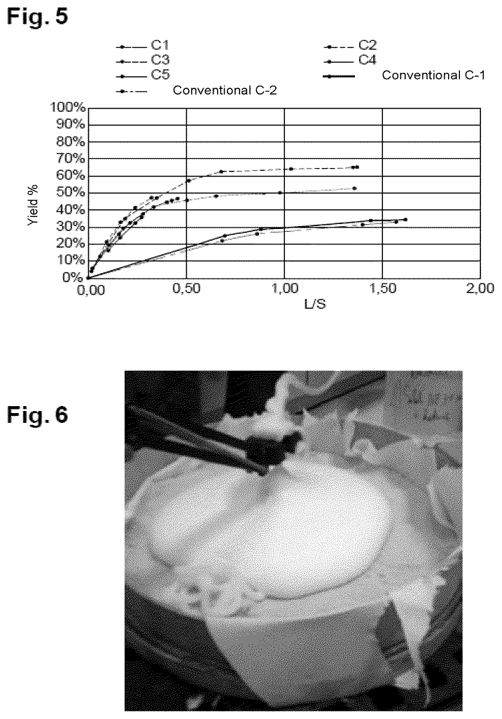

The leaching yield of uranium by foam at 10% liquid fraction was in particular measured for the 2 concentrations of surfactant (2 and 10 g/L) after 5 batches of foam 30 cm high and two batches 60 cm high (column 1 and 2 respectively) making it possible to achieve a quantity of liquid with respect to the ore greater than 1 (FIG. 5).

Uranium extraction yields in foam are greater than 50% for an addition of liquid greater than the initial quantity of solid (L/S >1) (FIG. 5), and can even achieve 65% for foam with 10 g/L of surfactant.

These two yields are compared with the yields obtained by drip mode of the industrial type on the same ore that do not exceed 30% (conventional irrigation on C-1 and C-2).

These results show the advantage of the method according to the invention: the foam extracts the uranium rapidly over the first centimetres of the heap (10 to 14 cm) by means of a homogeneous irrigation of the heap over the first centimetres.

### Example 3: Covering of a Foam on a Sand Heap by a Vertical Ejection Tube

Tests on the deposition/covering of a Glucopon leaching acidic foam with a 10% liquid fraction were implemented on a sand heap.

Three kilograms of NE 34 sand are deposited on an absorbent paper at the bottom of a mason's sieve 45 cm in diameter in order to form a heap of 0.16 m² over a thickness of 3-4 cm. A neutral Glucopon foam with 10% liquid fraction is deposited by means of a flexible tube of 8 mm inside diameter secured above the centre of the sieve at a height of 10 cm (FIG. 6).

The foam-generation rate is 2 L/min for 2 min and makes it possible to generate 4 litres of foam, which flows and gradually covers the heap, without touching the edges of the sieve. In the end of 2 min, the final disc of foam forms a radius of 20 cm and the foam therefore does not bear on the edges of the sieve. The mean thickness of foam deposited is approximately 6±1 cm. This result shows the possibility of easily covering the heap with a thickness of foam of 5 cm.

### Example 4: Covering of a Foam on Real Ore by Ejection by a Pipe in Flush Contact with the Heap

FIG. 7 illustrates the addition of the sulfate acid foam of example 2 with swelling 10 and a thickness of 5 cm on a heap of real uranium ore 40 cm in diameter by means of the horizontal flush tube in contact with the heap.

The covering forms a disc of foam the radius of which increases with time at a speed of approximately 7 cm/minute. The layer of foam easily repairs on the surface to eliminate the hollows and any air pockets.

### Example 5: Covering of a Foam on the Surface of a Heap with Surface Area Greater than 2 m²

A neutral foam (Glucopon 10 g/L) with liquid fraction of 10% is used on a surface of 1.5×1.5 m² of white-sand heap with granulometry of less than 2 mm. The experiments are conducted in a dedicated stainless-steel tank with a frame and grille supporting the heap of sand (5 to 10 cm).

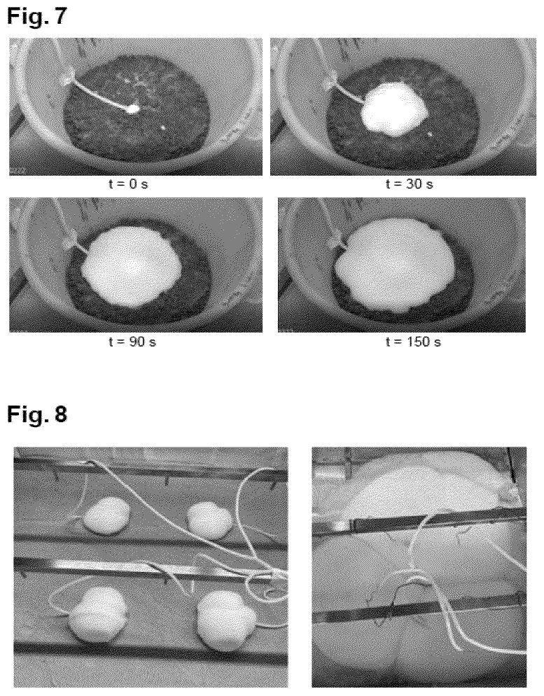

The foam is ejected from the generator onto the heap at 4 points distant by 50 cm (FIG. 8, spacing representative of pipes for industrial drip mode).

With the continuous injection of the foam, the four domes of foam formed end up by completely covering the surface of 2 m² with a 5 to 15 cm layer of foam according to the conditions of flow rate and liquid fraction of the foam.

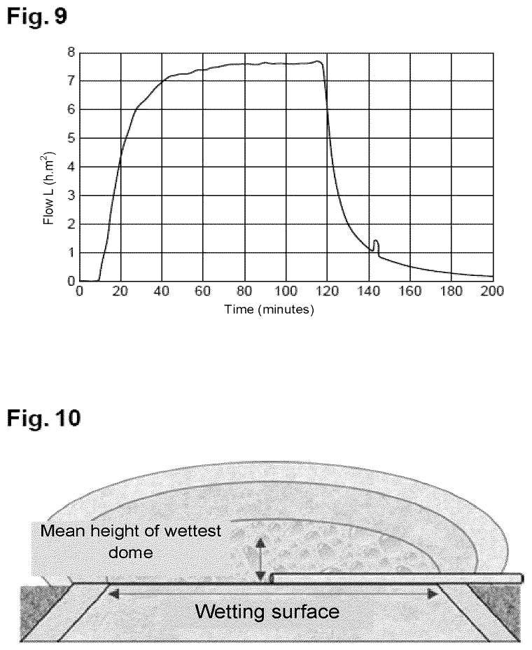

The tests on continuous supply of foam are implemented with an ejection rate of 1 L/min per supply point in order to reduce the mean height of the foam with 3.5% liquid fraction (FIG. 9).

In the end of one hour, the maximum flow reaches a flat level and the dimensions of the foam scarcely change further. The flow of 8 L/(h·m²) is here calculated with the total visual surface of the dome. The final dome measures approximately 120 cm resulting from the junction of 4 domes 60 cm in diameter with a mean maximum height of 25 cm by simple geometric measurement. In reality, the dome consists of the wettest layer of foam on the surface of the heap and then a liquid-fraction gradient over the thickness of the layer where the driest foam is located at the periphery (FIG. 10).

Under dynamic conditions, the real dimensions of the wetting of the final dome are obtained by destroying the dry foam on the surface of the dome by compressed air. The “wetted core” for its part remains stable under air flow. The parameters of the stabilised foam are a mean height of fresh foam of around 10 cm with a wetting diameter of 45 cm with an injection of 1 L/min per injector. Under these conditions, the stabilised maximum flow changes from 8 L/(h·m²) to 14 L/(h·m²). The continuous-supply tests (spacing 50 cm) show that a flow rate of 2 L/min of foam with 3.5% liquid fraction affords total coverage with the most complete wetting of the surface, with a flow of 10 L/(h·m²). Adjustments to the liquid fraction, to the injection rate and to the arrangement of the injectors thus make it possible to manage both the coverage and the height of foam on the surface of the heap as well as the permeation flow at the discharge from the heap.

### BIBLIOGRAPHIC REFERENCES

[1] Ghorbani et al, 2011, “Large particle effects in chemical/biochemical heap leach processes-A review”. Miner. Eng., Special Issue: Bio and Hydrometallurgy 24, 1172-1184. doi: 10.1016/j.mineng.2011.04.002.
[2] Patent U.S. Pat. No. 4,080,419 in the name of The United States of America as represented by the Secretary of the Interior, published on 21 Mar. 1978.
[3] Patent U.S. Pat. No. 6,099,615 in the name of Golden West Industries, published on 8 Aug. 2000.
[4] Patent application US 2013/045052 in the name of Golder Associates Inc., published on 21 Feb. 2013.
[5] International application WO 2004/008463 in the names of CEA and COGEMA, published on 22 Jan. 2004.
[6] International application WO 2016/202879 in the name of CEA, published on 22 Dec. 2016.
[7] «A quantitative kinetic theory of emulsion type, I. Physical chemistry of the emulsifying agent” Gas/Liquid and Liquid/Liquid Interface. Proceedings of the International Congress of Surface Activity (1957): 426-438.

1. A method for irrigating a porous substrate, the method comprising:
preparing a foam consisting of a dispersion of air bubbles in a foaming aqueous solution, wherein the foam comprises 15% by volume or less of a liquid fraction,
spreading, over the surface of the porous substrate, a layer of the prepared foam, wherein a thickness of the layer is greater than 5 cm, and then
maintaining the porous substrate having the layer on the surface for a sufficient time such that at least a part of the liquid fraction contained in the foam to percolates in the porous substrate.

2. The method according to claim 1,
wherein the porous substrate is selected from the group consisting of land, cultivated agricultural land, a green space, a stadium or terrain for sporting activity or a horticultural garden; sand; broken or fractured geological rocky formations; ore; ore concentrates; coal; mining residues; mining waste; slag; industrial, metallurgical and electronic waste; products containing strategic metals resulting from the recycling of lithium batteries, and a combination thereof.

3. The method according to claim 1, wherein the foam comprises from 5% to 15% by volume of the liquid fraction.

4. The method according to claim 1, wherein the spreading of the foam is repeated, wherein the foam is renewed by batches discontinuously or continuously at the surface of the porous substrate.

5. The method according to claim 1, wherein the foaming aqueous solution comprises at least one foaming organic surfactant.

6. The method according to claim 5, wherein the at least one foaming organic surfactant is at least one non-ionic foaming organic surfactant.

7. The method according to claim 5, wherein the at least one foaming organic surfactant is selected from the group consisting of alkylpolyglucosides, ethoxylated fatty alcohols and a combination thereof.

8. The method according to claim 5, wherein the at least one foaming organic surfactant is present, per litre of solution, in a quantity of from 0.1 g to 10 g.

9. The method according to claim 5, wherein the foaming aqueous solution further comprises at least one gelling or viscosifying organic agent.

10. The method according to claim 5, wherein the foaming aqueous solution further comprises at least one active ingredient.

11. The method according to claim 10, wherein the at least one active ingredient is selected from the group consisting of thiourea, a thiosulphate, a cyanide, a bicarbonate, an oxidant, an acid, and a combination thereof.

12. The method according to claim 10, wherein the at least one active ingredient is selected from the group consisting of a fertiliser, manure, urease, nitrification inhibitor, insecticide, repellent, herbicide, fungicide, bactericide, sporicide, algicide, germination inhibitor and chelating/complexing agent.

13. A method for recovering at least one element of interest contained in a porous substrate in the form of a heap, the method comprising:
irrigating the porous substrate according to the method of claim 1, and
recovering a permeation flow at a discharge from the heap and treating to recover the at least one element of interest.

14. The method according to claim 13, wherein the at least one element of interest is selected from the group consisting of gold, silver, uranium, platinum, palladium, lithium, nickel, cobalt, manganese, aluminum, zinc, copper, rare earths, niobium, tantalum, scandium and chromium.

15. A foam used in the method of claim 1, wherein the foam consisting of a dispersion of air bubbles in a foaming aqueous solution formed by:
a foaming organic surfactant or a mixture of foaming organic surfactants,
optionally an active ingredient or a mixture of active ingredients, and
water,
wherein the foam comprises less than 15% by volume of a liquid fraction.
